(19) United States
(12) Patent Application Publication
(10) Pub. No.: US 2015/0233400 A1
(43) Pub. Date: Aug. 20, 2015

(54) METHOD FOR CONTROLLING COMPRESSED AIR OUTPUT OF AN AIR COMPRESSION STATION

(71) Applicant: National Tsing Hua University, Hsinchu (TW)

(72) Inventor: Jia-Lin Liu, Hsinchu (TW)

(73) Assignee: National Tsing Hua University, Hsinchu (TW)

(21) Appl. No.: 14/250,885

(22) Filed: Apr. 11, 2014

(30) Foreign Application Priority Data
Feb. 14, 2014 (TW) 103104830

(51) Int. Cl. F15B 21/02

(52) U.S. Cl. CPC F15B 21/02

(57) ABSTRACT

A method for controlling compressed air output of an air compression station which supplies compressed air to a pneumatic apparatus comprises steps of: the air compression station recording a first consumption and a first estimated consumption of the compressed air supplied to the pneumatic apparatus in a first time interval; the air compression station using an EWMA method to estimate a second estimated consumption of the compressed air supplied to the pneumatic apparatus in a second time interval according to the first consumption and the first estimated consumption; and the air compression station generates and supplies the compressed air to the pneumatic apparatus in the second time interval according to the second estimated consumption. The present invention generates an appropriate amount of the compressed air according to the first consumption lest excessive compressed air causes waste.

### FIELD OF THE INVENTION

The present invention relates to a power-saving method for an air compression system, particularly to a method for dynamically regulating compressed air output of an air compression station.

### BACKGROUND OF THE INVENTION

Prosperity of sci-tech industries encourages fabrication automation. Automatic machines are usually driven by compressed air generated by air compression systems.

An air compression system normally includes an air compressor, a cooler, a filter, a delivery piping, etc. Generation of compressed air not only needs multiple procedures but also consumes a lot of energy. In a paper “A Review on Compressed-Air Energy Use and Energy Savings” published on Renewable and Sustainable Energy Reviews 14.4 (2010): 1135-1153, Saidur, R., N. A. Rahim, and M. Hasanuzzaman compared the fabrication costs using natural gas, steam, electricity and compressed air and concluded that compressed air is the most expensive utility fluid.

Most factories maintain the generation of the compressed air at the maximum. While suspending a portion of production lines or processes to reduce fabrication of products in response to decreased market demand, the factories do not decrease the production of the compressed air. The redundant compressed air is exhausted to the atmosphere. As the exhausted compressed air neither harms the environment not affects industry safety, much money is wasted in generating excessive compressed air unconsciously. Therefore, the conventional compressed-air technology suffers from many hidden wastes and has much room to improve.

### SUMMARY OF THE INVENTION

The primary objective of the present invention is to solve the problem that ordinary factories cannot effectively control the production of the compressed air and generate a lot of unnecessary compressed air, which not only causes wastes but also increases fabrication cost.

To achieve the abovementioned objectives, the present invention proposes a method for controlling compressed air output of an air compression station in a factory. The air compression station supplies compressed air to a pneumatic apparatus of the factory. The method comprises the following steps:

Step 1: recording a first consumption X₁ and a first estimated consumption Y₁ of the compressed air supplied to the pneumatic apparatus in a first time interval through the air compression station;

Step 2: using an EWMA (Exponential Weighting Moving Average) method to estimate a second estimated consumption Y₂ of the compressed air supplied to the pneumatic apparatus in a second time interval succeeding to the first time interval through the air compression station according to the first consumption X₁ and the first estimated consumption Y₁; and

Step 3: generating and supplying the compressed air to the pneumatic apparatus in the second time interval through the air compression station according to the second estimated consumption Y₂, wherein according to the EWMA method, the second estimated consumption Y₂ is expressed by

Y₂=aX₁+(1−a)Y₁

wherein a is a weighting coefficient ranging from 0.6 to 0.8.

The present invention is characterized in using an EWMA method to estimate a second estimated consumption Y₂ for a second time interval according to a first consumption X₁ and a first estimated consumption Y₁ in a first time interval, so that the air compression station can generate appropriate amount of compressed air according to the second estimated consumption Y₂. Therefore, the present invention can prevent the air compression station from generating excessive compressed air to avoid the unnecessary waste and reduce the fabrication cost.

### BRIEF DESCRIPTION OF THE DRAWINGS

FIG. 1 is a flowchart of a method for controlling compressed air output of an air compression station according to one embodiment of the present invention.

### DETAILED DESCRIPTION OF THE PREFERRED EMBODIMENTS

The technical contents of the present invention will be described in detail in cooperation with drawings below.

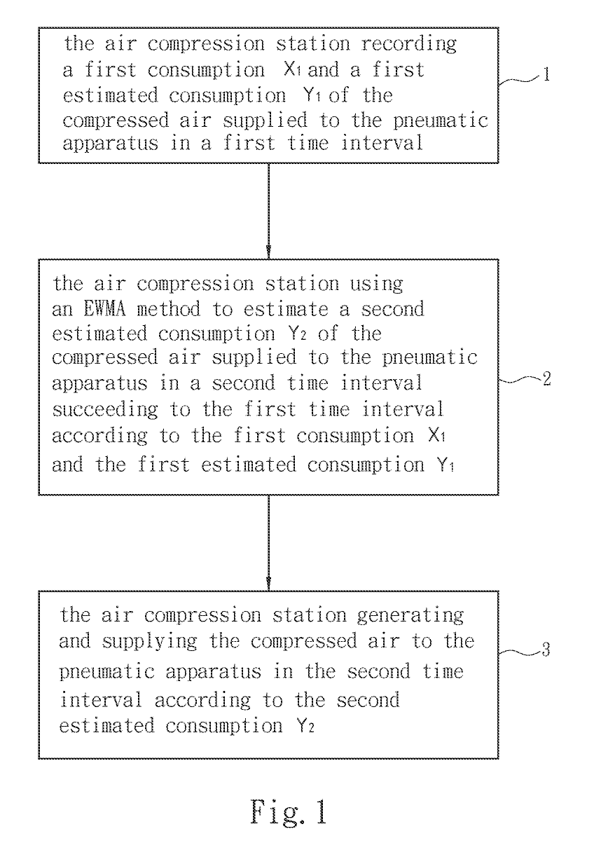

Refer to FIG. 1 for a flowchart of a method for controlling compressed air output of an air compression station according to one embodiment of the present invention. The present invention proposes a method for controlling compressed air output of an air compression station in a factory which has a pneumatic apparatus that is driven by the compressed air supplied by the air compression station to fabricate products. In one embodiment, the air compression station has a plurality of air compressors to generate compressed air. In one embodiment, the method of the present invention comprises the following steps.

Step 1: The air compression station records a first consumption X₁ and a first estimated consumption Y₁ of the compressed air supplied to the pneumatic apparatus in a first time interval, wherein the first time interval is an elapsed time interval having a length ranging from 4 to 8 hours. However, the present invention does not limit that the first time interval must be within 4-8 hours.

Step 2: The air compression station uses an EWMA (Exponential Weighting Moving Average) method to estimate a second estimated consumption Y₂ of the compressed air supplied to the pneumatic apparatus in a second time interval succeeding to the first time interval according to the first consumption X₁ and the first estimated consumption Y₁. In the present invention, the second time interval also ranges from 4 to 8 hours, and the length of the second time interval equals to that of the first time interval. In this embodiment, the second estimated consumption Y₂ for the second time interval is estimated according to the first consumption X₁ and the first estimated consumption Y₁ of the first time interval.

In the EWMA method, a greater weight is applied to the first consumption X₁ which is really supplied to the pneumatic apparatus in the first time interval, while a smaller weight is applied to the first estimated consumption Y₁ which is estimated for supplying to the pneumatic apparatus in the first time interval. Thereby, the second estimated consumption Y₂ required for the second time interval can be dynamically estimated according to the variation tendency of the first consumption X₁. In this embodiment, the second estimated consumption Y₂ is expressed by

Y₂=aX₁+(1−a)Y₁

wherein a is a weighting coefficient ranging from 0.6 to 0.8 and can be adjusted within a tolerance.

Step 3: The air compression station generates compressed air according to the second estimated consumption Y₂ and stores the compressed air for supplying to the pneumatic apparatus in the second time interval. The air compression station has a current output P of the compressed air which is generated by a plurality of operating air compressors and a plurality of standby air compressors.

In Step 3, while P−bY₂=S>0, it means that the current output P is greater than the second. estimated consumption Y₂ with the allowance, wherein b is an allowance coefficient ranging from 1.1 to 1.3; bY₂ is the second estimated consumption Y2 with the allowance; S is the redundant amount of the compressed air. In such a case, the air compression station would decrease the current output P of compressed air. The operating air compressor generating the redundant amount of the compressed air includes a high-energy consumption air compressor and a low-energy consumption air compressor. The air compression station should firstly turn off the high-energy consumption air compressor to reduce the current output P and appropriately generate the second estimated consumption Y, with the allowance.

In Step 3, while P−bY₂=I<0, it means that the current output P is smaller than the second estimated consumption Y₂ with the allowance, wherein b is an allowance coefficient ranging from 1.1 to 1.3; bY₂ is the second estimated consumption Y2 with the allowance; I is the insufficient amount of the compressed air. Insuch a case, the air compression station would increase the current output P of compressed air. The standby air compressor generating the insufficient amount of the compressed air includes a high-energy consumption air compressor and a low-energy consumption air compressor. The air compression station should firstly turn on the low-energy consumption air compressor to increase the current output P and generate the second estimated consumption Y₂ with the allowance.

In conclusion, the present invention uses an EWMA method to dynamically estimate a second estimated consumption required for a second time interval according to variation tendency of a first consumption in a first time interval, such that the air compression station can generate appropriate amount of compressed air according to the second estimated consumption to prevent the air compression station from massively generating excessive compressed air, whereby unnecessary waste is avoided and the fabrication cost of products is reduced. Further, the present invention firstly turns off the high-energy consumption air compressor according to the worked-out redundant amount or firstly turns on the low-energy consumption air compressor according to the worked-out insufficient amount to achieve an energy-saving effect.

What is claimed is:

1. A method for controlling compressed air output of an air compression station in a factory, the air compression station supplying compressed air to a pneumatic apparatus of the factory, comprising the steps of:
Step 1: recording a first consumption X₁ and a first estimated consumption Y₁ of the compressed air supplied to the pneumatic apparatus in a first time interval through the air compression station;
Step 2: using an EWMA (Exponential Weighting Moving Average) method to estimate a second estimated consumption Y₂ of the compressed air supplied to the pneumatic apparatus in a second time interval succeeding to the first time interval through the air compression station according to the first consumption X₁ and the first estimated consumption Y₁; and
Step 3: generating and supplying the compressed air to the pneumatic apparatus in the second time interval through the air compression station according to the second estimated consumption Y₂,
wherein according to the EWMA method, the second estimated consumption Y₂ is expressed by
Y₂=aX₁(1−a)Y₁
wherein a is a weighting coefficient ranging from 0.6 to 0.8.

2. The method according to claim 1, wherein a length of the second time interval equals to a length of the first time interval.

3. The method according to claim 2, wherein the length of the first time interval or the length of the second time interval ranges from 4 to 8 hours.

4. The method according to claim 1, wherein the air compression station has a current output P of the compressed air, and includes a plurality of operating air compressors for generating the compressed air, and wherein each of the plurality of operating air compressors includes a high-energy consumption air compressor and a low-energy consumption air compressor, and wherein while P−bY₂S>0 in Step 3, the operating air compressors generating a redundant amount of the compressed air such that the high-energy consumption air compressors are turned off to reduce generation of the compressed air, and wherein b is an allowance coefficient greater than 1, and wherein S is the redundant amount of the compressed air.

5. The method according to claim 4, wherein the allowance coefficient ranges from 1.1 to 1.3.

6. The method according to claim 1, wherein the air compression station has a current output P of the compressed air, and includes a plurality of standby air compressors for generating the compressed air, and wherein each of the plurality of standby air compressors includes a high-energy consumption air compressor and a low-energy consumption air compressor, and wherein while P−bY₂=I0 in Step 3, the standby air compressors generating an insufficient amount of the compressed air such that the low-energy consumption air compressors are turned on to increase generation of the compressed air, and wherein b is an allowance coefficient greater than 1, and wherein I is the insufficient amount of the compressed air.

7. The method according to claim 6, wherein the allowance coefficient ranges from 1.1 to 1.3.
